(19) United States
(12) Patent Application Publication
(10) Pub. No.: US 2009/0248984 A1
(43) Pub. Date: Oct. 1, 2009

(54) METHOD AND DEVICE FOR PERFORMING COPY-ON-WRITE IN A PROCESSOR

(75) Inventors: Xiao Wei Shen, Beijing (CN); Hua Yong Wang, Beijing (CN); Wen Bo Shen, Bejing (CN); Peng Shao, Beijing (CN)

Correspondence Address: IBM CORPORATION (SWP), C/O SUITER SWANTZ PC LLO, 14301 FNB PARKWAY, SUITE 220, OMAHA, NE, 68154-5299, US

(73) Assignee: International Business Machines Corporation, Armonk, NY (US)

(21) Appl. No.: 12/410,325

(22) Filed: Mar. 24, 2009

(30) Foreign Application Priority Data
Mar. 28, 2008 (CN) 200810086591.X

(51) Int. Cl. G06F 12/08; G06F 12/00

(52) U.S. Cl. 711/122; 711/E12.001; 711/E12.024; 711/E12.052

(57) ABSTRACT

There are disclosed a method and device for performing Copy-on-Write in a processor. The processor comprises: processor cores, L1 caches each of which is logically divided into a first L1 cache and a second L1 cache, and L2 caches. The first L1 cache is used for saving new data value, and the second L1 cache for saving old data value. The method can comprise the steps of: in response to a store operation from said processor core, judging whether a corresponding cache line in said L2 cache has been modified; if it is determined a corresponding L2 cache line in said L2 cache has not been modified, copying old data value in the corresponding L2 cache line to said second L1 cache, and writing new data value to the corresponding L2 cache line; and if it is determined a corresponding L2 cache line in said L2 cache has been modified, writing new data value to the corresponding L2 cache line directly.

### CROSS-REFERENCE TO RELATED APPLICATIONS

The present application claims the benefit under 35 U.S.C. § 119 of China; Application Serial Number 200810086951.X, filed Mar. 28, 2008 entitled “Method and Device for Performing Copy-On-Write in a Processor” which is incorporated herein by reference.

### FIELD OF THE INVENTION

The present invention generally relates to the field of data processing and, in particular, to a method and device for performing copy-on-write in a processor.

### BACKGROUND OF THE INVENTION

During the runtime, some computer programs need to cancel the modification of data, i.e. to restore data to a state before the modification. Such a restoration operation is usually called roll back.

In order to restore data to a state before the modification during roll back, two copies of data values (i.e. values of the data) need to be saved during the running period of an application process, one of which is old data value before the modification and the other of which is new data value after the modification. New data value after the modification is discarded and the data are restored to old data value during roll back. However, not only the saving two copies of data values during the running period of an application process occupies more storage space, but also the application process needs specific operations for saving and storing data. As a result, the overall performance is decreased greatly.

To solve the problem outlined above, the Copy-on-Write (COW) technology has been developed to record data. This technology hands over the task of copying and restoring data to underlying software and hardware, and programmers do not need to insert codes for copy and restoration into an application program, thereby reducing the difficulty of developing the application.

For a long time, Copy-on-Write is implemented in commercial processors by software-based methods, and there is no hardware-based Copy-on-Write. The reason is that software-based methods can satisfy the requirements of most traditional applications. However, as the computer technology evolves, some new applications, such as transactional memory, impose new demands such as high-speed and fine-grained copy-on-write, which impels developers to start considering hardware-based Copy-on-Write.

In recent years, in order to implement transactional memory, there have been proposed a variety of methods that support hardware-based Copy-on-Write. However, these methods have disadvantages of low operation efficiency and high complexity in hardware.

Therefore, there is a need in the art for a hardware-based Copy-on-Write method that has fine copy granularity and high efficiency.

### SUMMARY OF THE INVENTION

To this end, the present invention proposes a method and device for performing Copy-on-Write in a processor, in order to perform high-efficient data copy and restore at the granularity of a cache line.

According to an aspect of the present invention, there is provided a method for performing Copy-on-Write in a processor. The processor can comprise: processor cores, L1 caches each of which is logically divided into a first L1 cache and a second L1 cache, and L2 caches. The first L1 cache is used for saving new data value, and the second L1 cache for saving old data value. The method can comprise the steps of: in response to a store operation from said processor core, judging whether a corresponding cache line in said L2 cache has been modified; if it is determined a corresponding L2 cache line in said L2 cache has not been modified, copying old data value in the corresponding L2 cache line to said second L1 cache, and then writing new data value to the corresponding L2 cache line; and if it is determined a corresponding L2 cache line in said L2 cache has been modified, writing new data value to the corresponding L2 cache line directly.

According to another aspect of the present invention, there is provided a device for performing Copy-on-Write in a processor. The processor can comprise: processor cores, L1 caches each of which is logically divided into a first L1 cache and a second L1 cache, and L2 caches. The first L1 cache is used for saving new data value, and the second L1 cache for saving old data value. The device can comprise: judgment means for, in response to a store operation from said processor core, judging whether a corresponding cache line in said L2 cache has been modified; and copying and writing means for, if it is determined a corresponding L2 cache line in said L2 cache has not been modified, copying old data value in the corresponding L2 cache line to said second L1 cache and then writing new data value to the corresponding L2 cache line, and if it is determined a corresponding L2 cache line in said L2 cache has been modified, writing new data value to the corresponding L2 cache line directly.

According to a further aspect of the present invention, there is provided a processor system. The system can comprise: processor cores; L1 caches each of which is logically divided into a first L1 cache and a second L1 cache and which is coupled to said processor core, wherein said first L1 cache is used for saving new data value, and said second L1 cache for saving old data value; L2 caches which are coupled to the L1 caches; and controllers. The controller is configured to: judge, in response to a store operation from said processor core, whether a corresponding cache line in the L2 cache has been modified; copy old data value in the corresponding L2 cache line to the second L1 cache and then write new data value to the corresponding L2 cache line, if it is determined a corresponding L2 cache line in the L2 cache has not been modified; and write new data value to the corresponding L2 cache line directly, if it is determined a corresponding L2 cache line in the L2 cache has been modified.

### BRIEF DESCRIPTION ON THE DRAWINGS

Other features, advantages and other aspects of the present invention will become more apparent from the following detailed description, when taken in conjunction with the accompanying drawings wherein:

FIG. 1 is a schematic view of a computer system architecture in which the present invention can be applied;

FIG. 2 is a schematic view of a cache hierarchy in a processor in which the present invention can be applied;

FIG. 3 is a schematic view of a multi-core processor system in which the present invention can be applied;

FIG. 4 is a schematic layout view of a processor system according to an embodiment of the present invention;

FIG. 5 is a schematic view of the fundamental principle of a method for performing Copy-on-Write according to an embodiment of the present invention;

FIG. 6 is a flowchart of a method for performing Copy-on-Write according to an embodiment of the present invention; and

FIG. 7 is a flowchart of reading a message from a bus according to another embodiment of the present invention.

It is to be understood that like reference numerals denote the same parts throughout the figures.

### DESCRIPTION OF THE PREFERRED EMBODIMENTS

The fundamental principle of the present invention is to divide an L1 cache into two portions, namely an L1 cache A for saving new data value after modification and an L1 cache B for saving old data value before modification. When a process needs to perform a roll back operation, old data value in L1 cache B are restored to a corresponding L2 cache line in an L2 cache. Additionally, in order to perform high-efficiency data copy in the unit of a cache line, a flag T is set for each L2 cache line in L2 cache to indicate whether an L2 cache line has been modified in the present invention. In this manner, the present invention proposes a method for performing Copy-on-Write in L1 cache and L2 cache, which are near the processor core, in the copy unit of a cache line in order to achieve fine-grained and high-efficient hardware-based Copy-on-Write.

A detailed description will be given below to embodiments according to the present invention with reference to the accompanying drawings. It is to be understood that these embodiments are merely illustrative and not limiting the scope of the present invention.

First, description will be given to an application environment of the present invention with reference to the accompanying drawings.

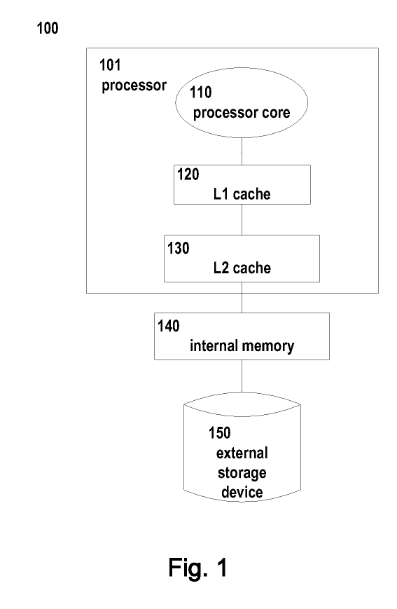

Referring to FIG. 1, it shows a computer system architecture 100 having a single processor core, in which the present invention can be applied. Architecture 100 can comprise a processor 101, an internal memory 140, and an external storage device 150 (e.g. a hard disk, optical disk, flash memory, etc.).

Processor 101 can comprise a processor core 110, an L1 cache 120, an L2 cache 130, etc. As is well known, access speeds of processor core 110 to L1 cache 120, L2 cache 130, internal memory 140, and external storage device 150 decrease in proper order.

Inside processor 101, L1 cache 120 is usually used for temporarily storing data in the procedure of processing data by processor core 110. Since instructions and data for cache work at the same frequency as the processor does, the presence of L1 cache 120 can reduce the number of times of data exchange between processor 101 and internal memory 140, thereby improving the operation efficiency of processor 101. Due to the limited capacity of L1 cache 120, L2 cache 130 is provided in order to further improve the operation speed of the processor core.

When processor core 110 reads data, it reads according to the order of L1 cache 120, L2 cache 130, internal memory 140, and external storage device 150. The “inclusive” policy is employed during the procedure of designing the multi-hierarchy storage structure outlined above. That is to say, all data in L1 cache 120 are included in L2 cache 130, all data in L2 cache 130 are contained in internal memory 140. In other words, L1 cache 120⊂L2 cache 130⊂internal memory 140.

According to an embodiment of the present invention, architecture 100 can further comprise respective storage controllers (not shown) for controlling operations of L1 cache 120, L2 cache 130, internal memory 140 and external storage device 150. Of course, the control of the above multi-hierarchy storage structure can also be achieved by a single storage controller.

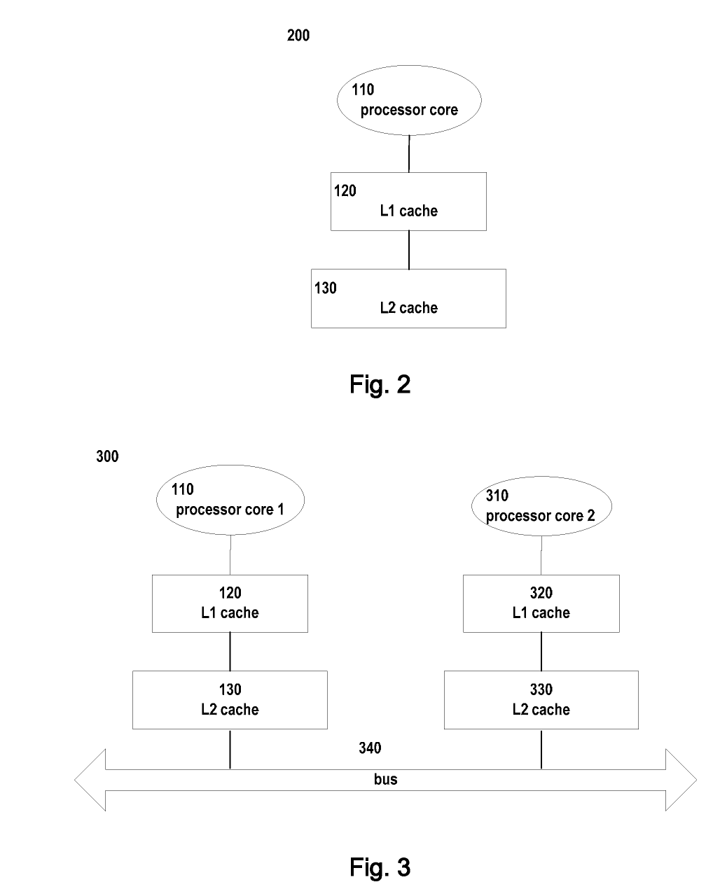

FIG. 2 shows a structure of cache hierarchy in a processor 200 in which the present invention can be applied. In processor 200, processor core 110 can be coupled to L1 cache 120, and L1 cache 120 can be coupled to L2 cache 130.

When processor core 110 is performing a loading operation, it first carries out a lookup in L1 cache 120. If L1 cache 120 hits, then data are directly returned from L1 cache 120; otherwise, processor core 110 tries loading data from L2 cache 130. If L2 cache 130 hits, then data are returned from L2 cache 130. It is known that the number of clock cycles taken by processor core 110 to perform operations to L1 cache 120 is significantly different from that of clock cycles taken by the same to perform operations to L2 cache 130. That is to say, the efficiency of operations to L1 cache 120 is significantly different from that of operations to L2 cache 130. The access to L1 cache 120 usually only costs several clock cycles, whereas the access to L2 cache 130 usually costs dozens of clock cycles.

When processor core 110 is performing a store operation, if L1 cache 120 misses, then data are sent to L2 cache 130 directly without passing L1 cache 120. If L1 cache 120 hits, then data are sent to both L1 cache 120 and L2 cache 130. It is because that the structure of L1-L2 two-hierarchy cache adopts the “inclusive” method as described above. That is, all data in L1 cache 120 are contained in L2 cache 130. As to be described later, the present invention makes improvements to the store operation procedure of the processor core.

Likewise, processor 200 can also comprise respective storage controllers (not shown) for controlling operations of L1 cache 120 and L2 cache 130. Of course, the control of L1 cache 120 and L2 cache 130 can also be achieved by a single cache controller.

Description will be given below to a multi-core processor system in which the present invention can be applied. In this multi-core processor, the structure of memory hierarchy in the processor is designed similarly to that in FIG. 2, and the difference is to maintain the coherency of data between multiple processor cores.

Referring to FIG. 3, it shows a schematic view of a multi-core processor system 300 in which the present invention can be applied.

As shown in FIG. 3, a processor core 1 110 can be coupled to L1 cache 120, L1 cache 120 to L2 cache 130, and L2 cache 130 to a bus 340. Likewise, a processor core 2 310 can be coupled to an L1 cache 320, L1 cache 320 to an L2 cache 330, and L2 cache 330 to bus 340.

When there are two or more processor cores in a computer system, a message indicative of the cache coherency between multiple processor cores can be transferred between respective processor cores via bus 340. Said cache coherency message means a message, after one of multiple processor cores modifies data in a cache shared by multiple processor cores, that is transferred over the bus in order to guarantee the data coherency of copies in multiple caches. As shown in FIG. 3, for example, processor core 1 110 and processor core 2 310 load the same data to L1 cache 120 and L2 cache 320 respectively. If one of the processor cores (e.g. processor core 2 310) modifies said data, then it will send a cache coherency message to the other processor core via bus 340, notifying the modification of the data, and carry out a subsequent cache coherency processing operation. Usually, the coherency of data in memories is maintained via a cache coherency protocol.

As is clear from the foregoing description, the state of a cache line might be changed in the following situations: (1) the loading/storing operation in the processor core; (2) cache coherency messages from the bus.

The environment in which the present invention can be applied has been described in detail. A detailed description will be given below to a method and system for performing hardware-based Copy-on-Write according to an embodiment of the present invention.

As is clear from the foregoing description, the speed of the processor core operating L1 cache 120 is far greater than that of the processor core operating L2 cache 130. Therefore, when performing Copy-on-Write, the present invention proposes a double cache method for L1 cache 120, in order to achieve high-efficient Copy-on-Write. Another advantage of performing Copy-on-Write in L1 cache 120 is the ability to provide fine-grained Copy-on-Write. That is to say, Copy-on-Write is performed in the unit of each cache line, whose granularity is far more advantageous than that of Copy-on-Write performed in the unit of a page (4k) in an internal memory of the prior art. Additionally, since each time of Copy-on-Write witnesses a smaller granularity and shorter time, the efficiency of Copy-on-Write is further improved.

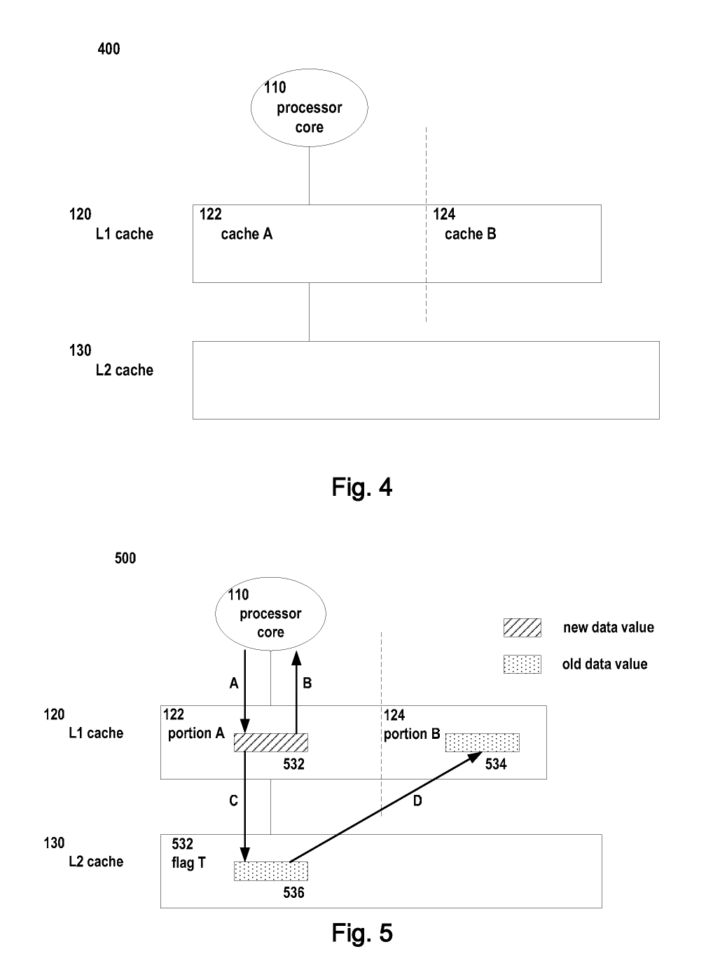

Referring to FIG. 4, a detailed description will be given below to a processor system 400 comprising a double L1 cache according to an embodiment of the present invention.

As shown in FIG. 4, processor system 400 can comprise processor core 110. Processor core 110 can be coupled to L1 cache 120, L1 cache 120 to L2 cache 130, L2 cache 130 to the internal memory or other processor via the bus.

Additionally, system 400 can also comprise an L1 cache controller and an L2 cache controller (not shown) for controlling various operations of L1 cache 120 and L2 cache 130 respectively. It is to be understood that the control of L1 cache 120 and L2 cache 130 can also be achieved by a single cache controller.

According to the present invention, L1 cache 120 can be logically divided into two portions, namely an L1 cache A 122 and an L1 cache B 124. When processor core 110 is executing in non-HCOW context, both L1 cache A 122 and L2 cache B 124 can be used as an L1 cache.

Additionally, according to an embodiment of the present invention, a flag T 532 is set for each cache line in L2 cache 130 to indicate the state of data in said cache line. For example, when a cache line is not modified, a flag corresponding to the cache line is set to 0; when the cache line is modified, the flag is set to 1. For another example, when data in a certain cache line are modified by HCOW store instructions (store instructions in HCOW context), a flag corresponding to the cache line is 1.

Alternatively, the flag can be set as follows: when a cache line is not modified, a flag corresponding to the cache line is set to 1; when the cache line is modified, the flag is set to 0.

Alternatively, the state of each L1 cache line can be recorded in the form of a table. It is to be understood that the present invention is not limited to the above form so long as the state of each L1 cache line in the L1 cache can be recorded.

In an embodiment of the present invention, when processor core 110 is executing in HCOW context, the operation of L1 cache A 122 is different from that of a conventional cache, whereas only old data values are saved in L1 cache B 124. At this point, every data stored via HCOW store instructions has two copies that are located in L1 cache A 122 and L1 cache B 122 respectively. L1 cache A 122 saves the new data value, and L2 cache B 124 saves the old data value. Once a roll back operation needs to be performed, restoration is carried out using the old data value saved in L1 cache B 124, and the data value saved in L1 cache A 122 is discarded.

Referring to FIG. 5 now, it shows the fundamental principle of a method for performing Copy-on-Write according to an embodiment of the present invention.

In a processor system 500 of FIG. 5, processor core 110 can be coupled to L1 cache 120, and L1 cache 120 to L2 cache 130. As described above, L1 cache 120 can be logically divided into two portions, namely L1 cache A 122 and L1 cache B 124.

As shown in FIG. 5, when processor core 110 is storing data (store operation) to a cache, if processor core 100 hits a cache line 532 in L1 cache A 122, processor core 110 saves new data value at cache line 532, as shown by arrow A in FIG. 5, and returns from cache A 122, as shown by arrow B.

Then, an L2 cache line corresponding to cache line 532 is looked up in L2 cache 130, and an L2 cache line 536 is found (as shown by arrow C).

According to an embodiment of the present invention, if a flag T 532 corresponding to L2 cache 536 has a value of 0, it indicates that L2 cache 536 is not modified. At this point, data value in L2 cache 536 are copied to a corresponding L1 cache line 534 in L1 cache B 124 (as shown by arrow D). Then, new data value are written to L2 cache line 536, and the value of the flag of L2 cache line 536 is set to 1, which indicates that L2 cache line 536 has been modified.

On the other hand, if the value of the flag T 532 corresponding to L2 cache 536 is 1, it indicates that data value in L2 cache line 536 were previously modified via HCOW store instructions. In this situation, data value in L2 cache line 536 do not need to be copied to L1 cache line 534 in L1 cache B 124 (because this cache line saves modified data value).

Features of an embodiment of the present invention comprise:

On the one hand, L1 cache 120 is logically divided into two portions, namely L1 cache A 122 and L1 cache B 124, for saving new data value after modification and old data value before modification respectively.

On the other hand, a flag T is set for each cache line in L1 cache to indicate whether data in this cache lines are modified, and to determine, according to a value of the flag T, whether to copy a cache line in L2 to a corresponding cache line in L1 cache B 124.

Through the above operation, new data value of the latest edition are stored in L1 cache A 122, and old data value of the corresponding old edition are stored in L1 cache B 124. When a roll back operation needs to be performed, data value in L1 cache B 124 are copied to a corresponding cache line in L2 cache as current value of the data, and data value in L1 cache A 122 are invalidated. If no roll back operation needs to be performed, then only data value in L1 cache B 124 are invalidated.

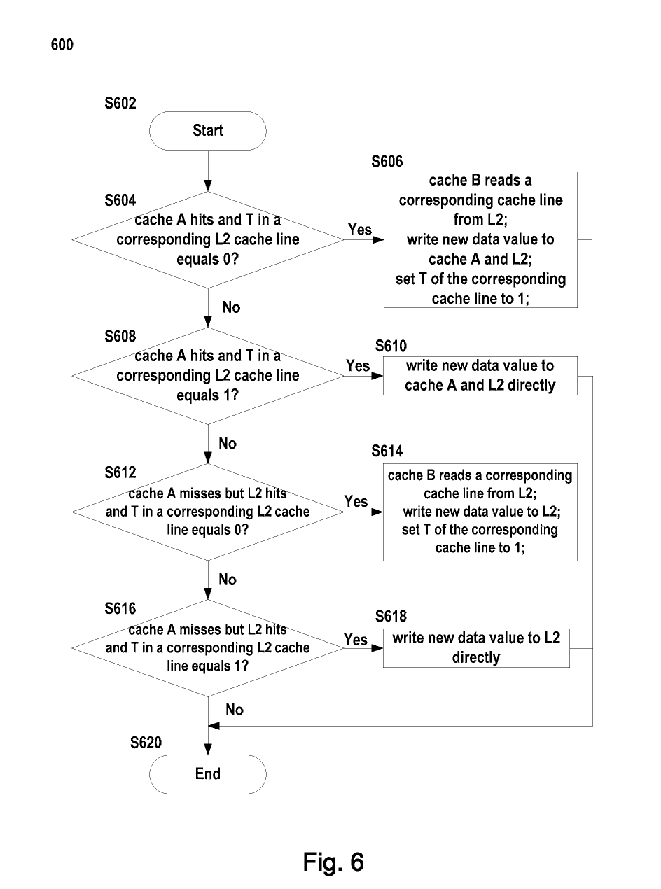

Referring to FIG. 6 in conjunction with FIG. 5, a detailed description will be given to a method for performing Copy-on-Write in a processor according to an embodiment of the present invention.

Usually, when a processor core is performing a store operation, the method for performing Copy-on-Write in a processor according to an embodiment of the present invention is initiated in step S602.

In step S604, judgment is made as to whether L1 cache A 122 hits and whether the value of a flag of a corresponding cache line in L2 cache 130 is 0. If yes, the processing proceeds to step S606, otherwise to step S608.

In step S606, data value in the corresponding cache line in L2 cache 130 are read to L1 cache B 124, and new data value are written to L1 cache A 122 and L2 cache 130, and the flag T of the corresponding L2 cache line is set to 1. Afterwards, the processing proceeds to step S620 where it ends.

In step S608, judgment is made as to whether L1 cache A 122 hits and whether the value of the flag of the corresponding cache line in L2 cache 130 is 1. If yes, the processing proceeds to step S610, otherwise to step S612.

In step S610, new data values are directly written to L1 cache A 122 and L2 cache 130. Then, the processing proceeds to step S620 where it ends.

In step S612, judgment is made as to whether L1 cache A 122 misses but L2 cache 130 hits and whether the flag of the corresponding L2 cache line is 0. If yes, the processing proceeds to step S614, otherwise to step S616.

In step S614, data value in the corresponding cache line in L2 cache 130 are read to L cache B 124, and new data value are written to L2 cache 130, and the value of the flag of the corresponding cache line in L2 cache 130 is set to 1. Then, the processing proceeds to step S620 where it ends.

In step S616, judgment is made as to whether L1 cache A 122 misses but L2 cache 130 hits and whether the flag of the corresponding L2 cache line is 1. If yes, the processing proceeds to step S618, otherwise to step S620 where it ends.

In step S618, new values are directly written to L2 cache 130. Then, the processing ends in S620.

It is to be understood that, it is not necessary for various steps shown in FIG. 1 to be carried out strictly in the illustrated order, and modifications in the order may fall in the scope of the present invention.

It is to be understood that in the situation where L1 cache hits, new data value can be written to L1 cache and judgment is made as to whether the corresponding L2 cache line has been modified.

Further, it is to be understood that in an embodiment of the present invention the ratio between L1 cache A 122 and L1 cache B 124 can be adjusted dynamically. Since data value saved in L1 cache B 124 are old values of data in L1 cache A 122, the maximum value of the number of cache lines in L1 cache B 124 equals to the number of cache lines in L1 cache A 122.

According to an embodiment of the present invention, L1 cache A 122 always saves new data value, and L1 cache B 124 saves old data value. When the process needs to perform a roll back operation, old data value in L1 cache B 124 are rolled back to corresponding cache lines in L2 cache 130. In this manner, the fine-grained and high-efficient hardware-based Copy-on-Write method can be achieved according to a first embodiment of the present invention.

Further, the present application also proposes a scheme for cache coherency messages from a bus in a multi-core processor system. In this scheme, the flag T set for each L2 cache line is utilized.

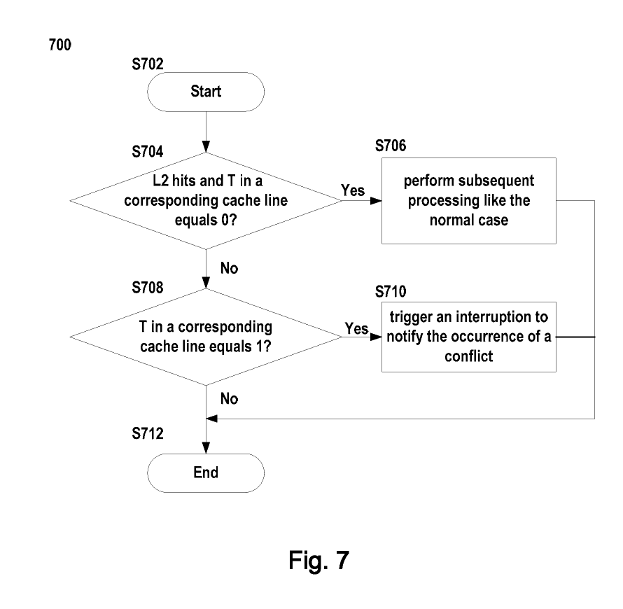

Specifically, referring to FIG. 7, it shows a flowchart of reading a message from a bus. The flow starts in step S702. In step S704, if L2 hits and the flag T in a corresponding L2 cache line equals 0, then L2 handles this message just like the normal case. If the flag T in the corresponding L2 cache line equals 1, it means conflict. Then, an interruption is triggered to notify the occurrence of a conflict event.

Additionally, the step for handling a kill message from the bus is the same as that for reading a message from the bus described previously. The processing flowchart is as shown in FIG. 7, and details thereof are omitted.

It is to be understood that respective features and steps of the above embodiments and variances thereof can be combined in any way in a real environment.

Furthermore, it is to be understood that the present invention can be implemented in software, firmware, hardware or a combination thereof. Those skilled in the art will recognize that the present invention may also be embodied in a computer program product arranged on a signal carrier medium to be used for any proper data processing system. Such signal carrier medium can be a transmission medium or a recordable medium used for machine readable information, including a magnetic medium, optical medium or other proper medium. Examples of a recordable medium include a floppy or magnetic disc in a hard disc drive, an optical disc for an optical drive, a magnetic tape, and other medium those skilled in the art can conceive. Those skilled in the art will further recognize that any communication terminal with proper programming means can perform the steps of the method of the present invention as embodied in a program product for example.

It is to be understood from the foregoing description that modifications and alterations can be made to all embodiments of the present invention without departing from the spirit of the present invention. The description in the present specification is intended to be illustrative and not limiting. The scope of the present invention is limited by the claims only.

1. A method for performing Copy-on-Write in a processor, wherein the processor comprises processor cores, L1 caches each of which are logically divided into a first L1 cache and a second L1 cache, and L2 caches, said first L1 cache being used for saving new data value and said second L1 cache for saving old data value, the method comprising the steps of:
in response to a store operation from said processor core, judging whether a corresponding cache line in said L2 cache has been modified;
if it is determined a corresponding L2 cache line in said L2 cache has not been modified, copying old data value in the corresponding L2 cache line to said second L1 cache, and writing new data value to the corresponding L2 cache line; and
if it is determined a corresponding L2 cache line in said L2 cache has been modified, writing new data value to the corresponding L2 cache line directly.

2. The method according to claim 1, wherein said judgment step further comprises judging whether said first L1 cache hits, and
writing new data value to said first L1 cache if it is determined said first L1 cache hits.

3. The method according to claim 1, wherein a flag is set for each cache line in said L2 cache to indicate a state of the cache line.

4. The method according to claim 3, wherein an initial value of the flag equals 0, and the value of the flag is set to 1 if the cache line has been modified.

5. The method according to claim 3, wherein an initial value of the flag equals 1, and the value of the flag is set to 0 if the cache line has been modified.

6. The method according to claim 1, further comprising restoring old data value in said second L1 cache to a corresponding L2 cache line in said L2 cache when a roll back operation needs to be performed.

7. The method according to claim 1, wherein the ratio between said first L1 cache and said second L1 cache can be adjusted dynamically.

8. A device for performing Copy-on-Write in a processor, wherein the processor comprises processor cores, L1 caches each of which is logically divided into a first L1 cache and a second L1 cache, and L2 caches, said first L1 cache being used for saving new data value and said second L1 cache for saving old data value, the device comprising:
judgment means for, in response to a store operation from said processor core, judging whether a corresponding cache line in said L2 cache has been modified; and
copying and writing means for, if it is determined a corresponding L2 cache line in said L2 cache has not been modified, copying old data value in the corresponding L2 cache line to said second L1 cache and writing new data value to the corresponding L2 cache line; and
if it is determined a corresponding L2 cache line in said L2 cache has been modified, writing new data value to the corresponding L2 cache line directly.

9. The device according to claim 8, wherein said judgment means further judges whether said first L1 cache hits, and
said copying and writing means writes new data value to said first L1 cache if said judgment means determines said first L1 cache hits.

10. The device according to claim 8, wherein a flag is set for each cache line in said L2 cache to indicate a state of the cache line.

11. The device according to claim 10, wherein an initial value of the flag equals 0, and a value of the flag is set to 1 if the cache line has been modified.

12. The device according to claim 10, wherein an initial value of the flag equals 1, and a value of the flag is set to 0 if the cache line has been modified.

13. The device according to claim 8, further comprising roll back means for restoring old data value in said second L1 cache to a corresponding L2 cache line in said L2 cache when a roll back operation needs to be performed.

14. The device according to claim 8, wherein the ratio between said first L1 cache and said second L1 cache can be adjusted dynamically.

15. A processor system, comprising:
processor cores;
L1 caches each of which is logically divided into a first L1 cache and a second L1 cache and which is coupled to said processor core, wherein said first L1 cache is used for saving new data value, and said second L1 cache for saving old data value;
L2 caches which are coupled to L1 caches; and
controllers which are configured to:
judge, in response to a store operation from said processor core, whether a corresponding cache line in said L2 cache has been modified;
copy old data value in the corresponding L2 cache line to said second L1 cache and write new data value to the corresponding L2 cache line, if it is determined a corresponding L2 cache line in said L2 cache has not been modified; and
write new data value to the corresponding L2 cache line directly, if it is determined a corresponding L2 cache line in said L2 cache has been modified.
